(19) United States
(12) Patent Application Publication
(10) Pub. No.: US 2020/0160212 A1
(43) Pub. Date: May 21, 2020

(54) METHOD AND SYSTEM FOR TRANSFER LEARNING TO RANDOM TARGET DATASET AND MODEL STRUCTURE BASED ON META LEARNING

(71) Applicant: Korea Advanced Institute of Science and Technology, Daejeon (KR)

(72) Inventors: Jinwoo Shin, Daejeon (KR); Sung Ju Hwang, Daejeon (KR); Yunhun Jang, Daejeon (KR)

(73) Assignee: Korea Advanced Institute of Science and Technology, Daejeon (KR)

(21) Appl. No.: 16/214,598

(22) Filed: Dec. 10, 2018

(30) Foreign Application Priority Data
Nov. 21, 2018 (KR) 10-2018-0144354

(51) Int. Cl. G06N 20/00

(52) U.S. Cl. CPC G06N 20/00

(57) ABSTRACT

Disclosed are a method and system for transfer learning to a random target dataset and model structure based on meta learning. A transfer learning method may include determining the form and amount of information to be transferred, used by a pre-trained model, using a meta model based on similarity between a source dataset and a new target dataset and performing transfer-learning on a target model using the form and amount of information of the pre-trained model determined by the meta model.

### CROSS REFERENCE TO RELATED APPLICATION

The present application claims the benefit of Korean Patent Application No. 10-2018-0144354 filed in the Korean Intellectual Property Office on Nov. 21, 2018, the entire contents of which are incorporated herein by reference.

### BACKGROUND OF THE INVENTION

### 1. Technical Field

The following embodiments relate to the transfer learning of a deep learning model and, more particularly, to a transfer learning method and system for a random target dataset and model structure based on meta learning.

### 2. Description of the Related Art

Recently, a deep learning model shows innovative performance in the fields, such as computer vision, voice recognition and natural language processing. However, such a deep learning model requires much training data labeled for training and must newly collect a large amount of labeling training data whenever a model for performing a new kind of task is implemented.

In order to overcome such problems, transfer learning schemes of various methods are being searched. Transfer learning is a scheme used to train a new target model so that the target model shows better performance even with a small number of training data using knowledge of a pre-trained model. The most commonly used transfer learning method is a fine-tuning method of setting the parameter of a pre-trained model, trained by a large amount of training data, as the initial parameter of a new target model and training the new target model using the training data of a new target dataset. However, this method has a problem in that it is difficult to apply if a target dataset is greatly different from the existing source dataset or if the structure of a new model is different from a pre-trained model.

In order to solve such a problem, various transfer learning schemes have been suggested, but are problematic in that it is difficult to perform transfer learning on a random target dataset and model structure. In general, transfer to a similar target dataset or transfer to the same structure help to improve performance of a target model, but if not, it is difficult to design a transfer learning method in any situation because information of a pre-trained model may hinder object function optimization for the training of the target model.

Korean Patent No. 10-1738825 relates to a training method based on a deep learning model having a discontiguously probability neuron and knowledge propagation, and describes a technology for designing a deep learning model having the same number of variables as the existing deep learning model.

### PRIOR ART DOCUMENT

### Patent Document

(Patent Document 1) Korean Patent No. 10-1738825

### Non-Patent Document

(Non-Patent Document1) Manzil Zaheer, Satwik Kottur, Siamak Ravanbakhsh, Barnabas Poczos, Ruslan R Salakhutdinov, 324 and Alexander J Smola. Deep sets. In Advances in Neural Information Processing Systems, 325 pages 3394-3404, 2017.

### SUMMARY OF THE INVENTION

Embodiments relate to a method and system for transfer learning to a random target dataset and model structure based on meta learning. More specifically, embodiments provide a transfer learning technology for improving performance of a new target model that trains a new target dataset using a deep learning model previously trained using a source dataset.

Embodiments provide a method and system for transfer learning to a random target dataset and model structure based on meta learning, which provide a meta model for determining a degree of transfer and a form of transfer information by taking into consideration an associative relation between a pre-trained model and source dataset and the structure of a new target model and a target dataset when the pre-trained model and the source dataset are given.

A transfer learning method according to an embodiment may include the steps of determining the form and amount of information to be transferred, used by a pre-trained model, using a meta model based on similarity between a source dataset and a new target dataset and performing transfer-learning on a target model using the form and amount of information of the pre-trained model determined by the meta model.

The transfer learning method may further include the step of generating a virtual source dataset and a virtual target dataset through the source dataset used by the pre-trained model, training a virtual pre-trained model and a virtual target model, and training the meta model in order to be of help to the training.

The step of determining the form and amount of information to be transferred using a meta model may include the steps of generating an attention map to be used for the transfer learning as output when the feature map of the pre-trained model or target model is input to a first meta model as input and determining the form of information to be transferred in the transfer learning and determining the amount of data to be transferred in each of the pre-trained model and the target model, using a second meta model based on the similarity between the source dataset and the target dataset.

In the step of determining the amount of data to be transferred, the amount of data to be transferred may be a constant value output through the second meta model, and the constant value may be differently applied for each pair of layers.

In the step of performing transfer learning on the target model, the transfer learning may be performed in such a manner that the attention map of the target model generated through the meta model becomes similar to the attention map of the pre-trained model generated through the meta model.

In the step of performing transfer learning on the target model, the transfer learning may be performed to reduce an additional loss in such a manner that the attention map of the target model generated through the meta model becomes similar to the attention map of the pre-trained model generated through the meta model.

In the step of training the meta model, the meta model and the virtual target model may be trained to minimize a loss function.

The pre-trained model and the target model may include a deep learning model, and the target model may be trained through the new target dataset using a previously trained deep learning model.

A transfer learning system implemented as a computer according to another embodiment includes at least one processor implemented to execute instructions readable by a computer. The at least one processor may be configured to determine the form and amount of information to be transferred, used by a pre-trained model, using a meta model based on similarity between a source dataset and a new target dataset and to perform transfer-learning on a target model using the form and amount of information of the pre-trained model determined by the meta model.

The at least one processor may be configured to generate a virtual source dataset and a virtual target dataset through the source dataset used by the pre-trained model, train a virtual pre-trained model and a virtual target model, and train the meta model in order to be of help to the training.

The at least one processor may be configured to determine the form and amount of information to be transferred using the meta model, generate an attention map to be used for transfer learning as output when the feature map of the pre-trained model or target model is input to a first meta model as input and determine the form of information to be transferred in the transfer learning, and determine the amount of data to be transferred in each of the pre-trained model and the target model, using a second meta model based on the similarity between the source dataset and the target dataset.

The at least one processor may be configured to perform transfer learning on the target model and to perform the transfer learning in such a manner that the attention map of the target model generated through the meta model becomes similar to the attention map of the pre-trained model generated through the meta model.

A transfer learning system according to yet another embodiment may include a meta model unit configured to determine the form and amount of information to be transferred, used by a pre-trained model, based on similarity between a source dataset and a new target dataset. The meta model unit may include a first meta model of generating an attention map to be used for transfer learning as output when the feature map of the pre-trained model or a target model is received as input and determining the form of information to be transferred in the transfer learning and a second meta model of determining the amount of data to be transferred in each layer of the pre-trained model and the target model based on the similarity between the source dataset and the target dataset.

Furthermore, the transfer learning system may further include a meta model training unit configured to generate a virtual source dataset and a virtual target dataset through the source dataset used by the pre-trained model, train a virtual pre-trained model and a virtual target model, and train the meta model in order to be of help to training.

Furthermore, the transfer learning system may further include a transfer learning unit configured to perform transfer learning on the target model using the form and amount of information to be transferred, determined by the meta model.

The amount of data to be transferred may be a constant value output through the second meta model, and the constant value may be differently applied for each pair of layers.

The transfer learning unit may perform transfer learning in such a manner that the attention map of the target model generated through the meta model becomes similar to the attention map of the pre-trained model generated through the meta model.

The transfer learning unit may be trained to reduce an additional loss when the transfer learning is performed in such a manner that the attention map of the target model generated through the meta model becomes similar to the attention map of the pre-trained model generated through the meta model.

The meta model training unit trains the meta model and the virtual target model to minimize a loss function.

The pre-trained model and the target model may include a deep learning model, and the target model may be trained through the new target dataset using a previously trained deep learning model.

### BRIEF DESCRIPTION OF THE DRAWINGS

FIG. 1 is a diagram schematically showing the structure of a transfer learning system according to an embodiment.

FIG. 2 is a diagram for illustrating a process of generating a virtual source dataset and a target dataset using a source dataset according to an embodiment.

FIG. 3 is a flowchart illustrating a transfer learning method according to an embodiment.

FIG. 4 is a flowchart illustrating a method of determining information to be transferred using a meta model according to an embodiment.

FIG. 5 is a block diagram of a transfer learning system according to an embodiment.

### DETAILED DESCRIPTION

Hereinafter, embodiments of the present invention are described in detail with reference to the accompanying drawings. However, the described embodiments may be modified in other various forms, and the scope of the present invention is not restricted by the following embodiments. Furthermore, the embodiments of the present invention are intended to fully describe the present invention to a person having ordinary knowledge in the art to which the present invention pertains. In the drawings, the shapes, sizes, etc. of components in the drawings may be exaggerated to make the description clear.

The following embodiments can improve performance when transfer learning for a random model structure and dataset is performed by solving the similarity dependence problem of a model structure and dataset for transfer learning. The existing common weight initialization & fine-tuning scheme has problems in that a new target dataset must be similar to the existing source dataset and model structures must be the same. In order to solve such problems, there is provided a method capable of designing and training a meta model (or meta network) for determining a form and degree of transfer learning based on similarity and a model structure for the source dataset of a target dataset.

The present embodiments relate to a transfer learning method and system for a random target dataset and model structure based on meta learning. More specifically, the embodiments can provide a transfer learning method and system for improving performance of a new target model that trains a new target dataset through a deep learning model previously trained using a large source dataset. Such a transfer learning method and system for a random target dataset and model structure based on meta learning may provide (1) a meta model for determining a degree of transfer using the similarity relation between a dataset (source dataset) used by the existing pre-trained model and a new target dataset, (2) a scheme for designing and training a meta model that determines a form of information to be transferred, and (3) a transfer learning scheme using a meta model.

The proposed meta model may determine a degree of transfer and a form of transfer information by taking into consideration an associative relation between a pre-trained model and source dataset and the structure of a new target model and a target dataset when the pre-trained model and the source dataset are given.

Structure of Meta Model

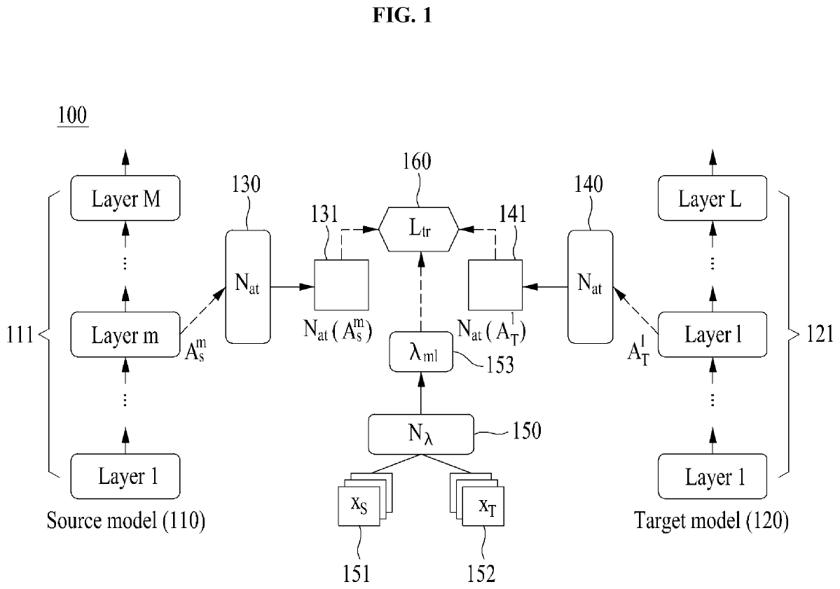

FIG. 1 is a diagram schematically showing the structure of a transfer learning system according to an embodiment.

Referring to FIG. 1, there may be provided a transfer learning system 100 for a random target dataset and model structure based on meta learning using meta models, a pre-trained model and target models.

The transfer learning system 100 for a random target dataset and model structure based on meta learning may include a pre-trained model (or source model) 110, a target model 120, and meta models 130, 140 and 150. In this case, the meta models 130, 140 and 150 may be classified into first meta models 130 and 140 of determining a form of information to be transferred and a second meta model 150 of determining the amount of data to be transferred in transfer learning.

Nₐₜ and N_{λ}, are meta models 130, 140 and 150 of determining a form of information to be transferred, and a layer where transfer occurs, and the amount of information, respectively. Furthermore, x_{S} and x_{T} are data samples (e.g., images) of a source dataset 151 and a target dataset 152, respectively. The pre-trained model 110 and the target model 120 may have different model structures.

The first meta model 130, 140 [symbol] ₐₜ is a meta model of generating an attention map to be used for transfer learning as output when the feature map of the pre-trained model 110 or target model 120 is received as input. The first meta model may function to determine a form of information to be transferred in transfer learning. In this case, the first meta model 130, 140 [symbol] ₐₜ may include a single meta model. Furthermore, the first meta model may include two separate meta models.

The second meta model 150 [symbol] _{λ} may output a constant value 153 λ to determine the amount of data to be transferred in the layers 111 and 121 of the pre-trained model 110 and the target model 120 by taking into consideration similarity between the source dataset 151 and the target dataset 152 when the source dataset 151 and the target dataset 152 are given. In this case, a deep sets (NIPS 2017, Non-Patent Document1) structure may be used as a feature representation of the source dataset 151 and the target dataset 152, that is, input.

In this case, each model includes a neural network based on a convolutional neural network (CNN), and may use various forms of model structures without a special restriction.

The first meta models 130 and 140 and the second meta model 150 may be used to distill trained knowledge of the pre-trained model 110 when the target model 120 is trained if the pre-trained model 110 is given. A detailed method of training the meta model and a detailed method of training the target model 120 using the method are described below.

Training of Meta Model

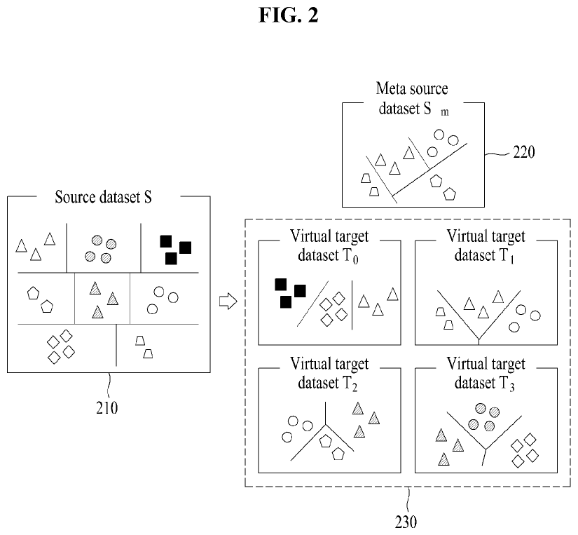

FIG. 2 is a diagram for illustrating a process of generating a virtual source dataset and a target dataset using a source dataset according to an embodiment.

In a meta learning step of training a meta model, it is important to similarly simulate a situation used when a target model is actually trained. Accordingly, there is a need for pairs of a source dataset and a target dataset capable of simulating the relation between the source dataset and the target dataset when transfer learning is actually performed in the training of meta models used so that transfer learning for the target dataset and the target model are effectively performed if the source dataset and a pre-trained model are given.

To this end, as shown in FIG. 2, a virtual source dataset 220 and virtual target datasets 230 may be generated using the existing source dataset 210. In this process, class labels provided by the source dataset 210 may be divided, some of the divided labels may be configured to belong to only the virtual source dataset 220, and the virtual target dataset 230 may be configured to permit overlap with the classes of the virtual source dataset 220 and to have various similarities. A virtual pre-trained model and a virtual target model may be trained using such a process, and a meta model may be trained to give help in this process.

In this case, a meta model and a virtual target model may be trained to minimize a loss function [symbol] ₘₑₜₐ, and may be expressed as in the following equation.

$$\begin{matrix}{ℒ}_{meta} ( θ , {φ}_{at} , {φ}_{λ} \vert \{ {x}_{S} \} , \{ {x}_{T} \} ) = {ℒ}_{org} ( θ \vert \{ {x}_{T} \} ) + {ℒ}_{tr} ( θ , {φ}_{at} , {φ}_{λ} \vert \{ {x}_{S} \} . \{ {x}_{T} \} ) & [ Equation 1 ] \\ {ℒ}_{tr} ( θ , {φ}_{at} , {φ}_{λ} \vert \{ {x}_{S} \} , \{ {x}_{T} \} ) = {\sum }_{m = 1}^{M} {\sum }_{𝓁 = 1}^{L} {λ}_{m 𝓁} {Σ}_{{x}_{T}} {‖ \frac{{𝒩}_{at} ( {φ}_{at} , {A}_{S}^{m} )}{‖ {{𝒩}_{at} ( {φ}_{at} , {A}_{S}^{m} ‖}_{2}} - \frac{{𝒩}_{AT} ( {φ}_{at} , {A}_{T}^{𝓁} )}{‖ {{𝒩}_{at} ( {φ}_{at} , {A}_{T}^{𝓁} ‖}_{2}} ‖}_{p} & [ Equation 2 ]\end{matrix}$$

In Equations 1 and 2, {x_{S}} and {x_{T}} are a source dataset and a target dataset, respectively. M and L are the number of layers of a pre-trained model and the number of layers of a target model, respectively. θ, ϕₐₜ and ϕ_{λ} are the parameters of the target model, [symbol] ₐₜ and [symbol] _{λ}. Furthermore, λₘₗ is output of [symbol] _{λ}, and may determine the degree that transfer occurs between the m-th layer of the pre-trained model and the 1-th layer of the target model.

A target model is trained to minimize the above-described loss function with respect to training data. Meta models may be trained so that the trained target model has a low error with respect to test data.

Table 1 shows a meta model training algorithm.

TABLE 1
Algorithm 1 Training meta-transfer networks

Input: Source dataset S, pretrained source model, randomly initialized N target models
Output: Meta-transfer networks, [symbol] ₐₜ, [symbol] _{λ}

| | |
|---|---|
| 1: | Construct meta-source task Sₘₑₜₐ, and N virtual target tasks T_{i=1, . . . , N} |
| 2: | while not done do |
| 3: | [symbol] ₜₑₛₜ ← 0 |
| 4: | for all i = 1, . . . , N do |
| 5: | Sample data samples {x_{T}_{ᵢ}} from training set of Tᵢ |
| 6: | Sample data samples {x_{T}_{ᵢ}_{,test}} from test set of Tᵢ |
| 7: | Sample data samples {x_{S}_{ₘₑₜₐ}} from training set of Sₘₑₜₐ |
| 8: | Compute [symbol] ₘₑₜₐ (2) |
| 9: | θ_{T}_{ᵢ}^{(t)} ← θ_{T}_{ᵢ}^{(t-1)} − α_{θ}∇_{θ(t-1)} [symbol] ₘₑₜₐ(θ_{T}_{ᵢ}^{(t-1)},ϕₐₜ^{(t-1)},ϕ_{λ}^{(t-1)}\|{x_{S}_{ₘₑₜₐ}},{x_{T}_{ᵢ}}) |
| 10: | [symbol] ₜₑₛₜ ← [symbol] ₜₑₛₜ + [symbol] _{org}(θ_{T}_{ᵢ}^{(t)}\|{x_{T}_{ᵢ}_{,test}}) |
| 11: | end for |
| 12: | ϕₐₜ^{(t)} ← ϕₐₜ^{(t-1)} − α∇_{ϕ}_{ₐₜ}^{_{(t−1)}} [symbol] ₜₑₛₜ |
| 13: | ϕ_{λ}^{(t)} ← ϕ_{λt}^{(t-1)} − α∇_{ϕλ}^{_{(t−1)}} [symbol] ₜₑₛₜ |
| 14: | end while |

Training of the Target Model

The training of a target model is the same as the training process of a meta model except that the parameter of the meta model is fixed. That is, in the meta model training algorithm of Table 1, an algorithm except a part (i.e., line 1) in which a virtual target dataset is generated and parts (i.e., lines 10, 12 and 13) in which the parameter of a meta model is updated may be applied without any changed.

Accordingly, the target model may be trained by useful information received using the attention map of a pre-trained model.

That is, referring back to FIG. 1, transfer learning between the pre-trained model 110 and the target model 120 is performed in such a manner that the attention map 141 of the target model 120 generated by the first meta model 140 [symbol] ₐₜ becomes similar to the attention map 131 of the pre-trained model 110 generated by the first meta model 130 [symbol] ₐₜ. In this case, the transfer learning may be performed to reduce an additional loss 160 [symbol] ₜᵣ.

Furthermore, the degree of transfer has the constant value 153 λₘₗ determined by the second meta model 150 [symbol] _{λ}. In this case, the constant value 153 λₘₗ is differently applied to each pair of the layers 111 and 121, thus dynamically determining the amount of data to be transferred necessary for each layer 111, 121 according to the dataset 151, 152.

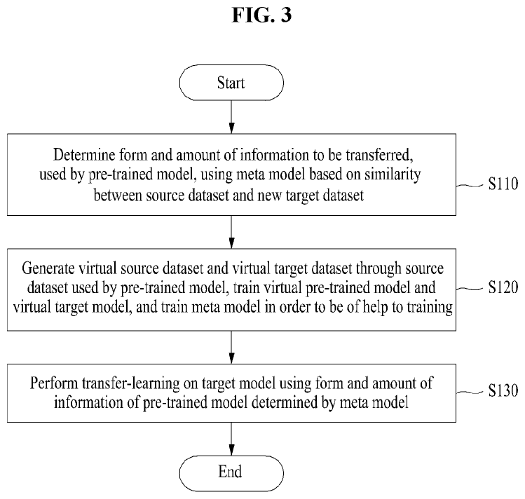

FIG. 3 is a flowchart illustrating a transfer learning method according to an embodiment.

Referring to FIG. 3, the transfer learning method according to an embodiment may include step S110 of determining the form and amount of information to be transferred, used by a pre-trained model, using a meta model based on similarity between a source dataset and a new target dataset, and step S130 of performing transfer-learning on a target model using the form and amount of information of the pre-trained model determined by the meta model.

The transfer learning method may further include step S120 of generating a virtual source dataset and a virtual target dataset through the source dataset used by the pre-trained model, training a virtual pre-trained model and a virtual target model, and training the meta model in order to be of help to the training.

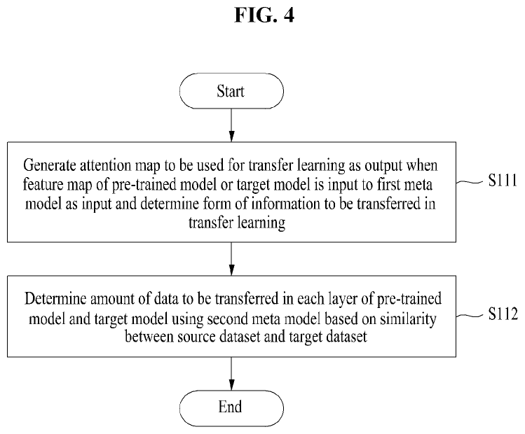

FIG. 4 is a flowchart illustrating a method of determining information to be transferred using a meta model according to an embodiment.

Referring to FIG. 4, step S110 of determining the form and amount of information to be transferred using the meta model may include step S111 of generating an attention map to be used for transfer learning as output when the feature map of a pre-trained model or target model is input to a first meta model as input and determining the form of information to be transferred in the transfer learning and step S112 of determining the amount of data to be transferred in each layer of the pre-trained model and the target model using a second meta model based on similarity between a source dataset and a target dataset.

In accordance with embodiments, there can be provided a meta model design method of determining the degree and form of transfer learning by taking into consideration between a pre-trained model and a source dataset, a new target model and a target dataset when a new model having a small dataset is trained by improving the existing transfer learning method, and a method of training a meta model and a transfer learning method for the meta model design method.

An example of a transfer learning method according to an embodiment is described below.

A transfer learning method according to an embodiment may be described in detail by taking a transfer learning system as an example.

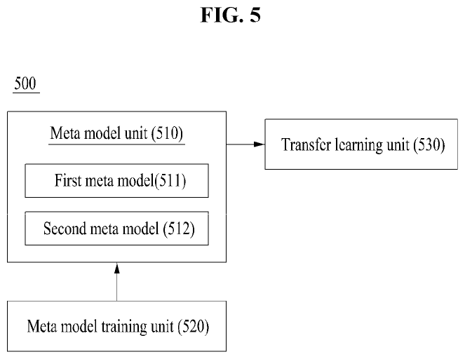

FIG. 5 is a block diagram of a transfer learning system according to an embodiment.

Referring to FIG. 5, the transfer learning system 500 according to an embodiment may include a meta model unit 510. The meta model unit 510 may include a first meta model 511 and a second meta model 512. Furthermore, in some embodiments, the transfer learning system 500 may further include a meta model training unit 520 and a transfer learning unit 530.

In step S110, the meta model unit 510 may determine the form and amount of information to be transferred, used by a pre-trained model, based on similarity between a source dataset and a new target dataset.

In this case, the meta model unit 510 may include the first meta model 511 and the second meta model 512.

More specifically, in step S111, the first meta model 511 may generate an attention map to be used for transfer learning as output when the feature map of a pre-trained model or target model is received as input, and may determine a form of information to be transferred in the transfer learning.

Furthermore, in step S112, the second meta model 512 may determine the amount of data to be transferred in each layer of the pre-trained model and a target model based on the similarity between the source dataset and of the target dataset. In this case, as described with reference to FIG. 1, the amount of data to be transferred may be a constant value output through the second meta model 512. In this case, the constant value may be differently applied to for each pair of layers, and the amount of data to be transferred necessary for each layer may be dynamically determined based on a dataset.

The pre-trained model and the target model may include a deep learning model. That is, the target model, that is, a deep learning model, may be trained through the new target dataset using the pre-trained model, that is, a previously trained deep learning model.

In some embodiments, the transfer learning system 500 may further include the meta model training unit 520 and the transfer learning unit 530.

In step S120, the meta model training unit 520 may generate a virtual source dataset and a virtual target dataset through the source dataset used by the pre-trained model, may train a virtual pre-trained model and a virtual target model, and may train a meta model in order to be of help to the training. That is, the meta model training unit 520 may train a meta model so that transfer learning for a target dataset and a target model is performed.

In this case, the meta model training unit 520 may train the meta model and the virtual target model to minimize a loss function. This has been described with reference to FIG. 2, and a detailed description thereof is omitted.

In step S130, the transfer learning unit 530 may perform transfer-learning on the target model using the form and amount of information to be transferred, which has been determined by the meta model. That is, the transfer learning unit 530 may receive the trained information of the pre-trained model from the meta model and train the target model. In particular, the target model may receive useful information using the attention map of the pre-trained model and train a new target dataset.

More specifically, the transfer learning unit 530 may perform transfer-learning in such a manner that the attention map of the target model generated through the meta model becomes similar to the attention map of the pre-trained model generated through the meta model. In this case, the transfer learning unit 530 may be trained to reduce an additional loss when the transfer learning is performed so that the attention map of the target model generated through the meta model becomes similar to the attention map of the pre-trained model generated through the meta model.

The transfer learning method may be implemented through a transfer learning system implemented as a computer. In particular, in the transfer learning system implemented as a computer, the transfer learning method may be implemented through at least one processor implemented to execute instructions readable by the computer.

The transfer learning system implemented as a computer according to another embodiment may include at least one processor implemented to execute instructions readable by a computer. In this case, the at least one processor may determine the form and amount of information to be transferred, used by a pre-trained model, using a meta model based on similarity between a source dataset and a new target dataset, and may perform transfer-learning on a target model using the form and amount of information to be transferred of the pre-trained model, which has been determined by the meta model.

Furthermore, the at least one processor may generate a virtual source dataset and a virtual target dataset through a source dataset used by a pre-trained model, may train a virtual pre-trained model and a virtual target model, and may train a meta model in order to be of help to the training.

Furthermore, the at least one processor may determine the form and amount of information to be transferred using a meta model, may generate an attention map to be used for transfer learning as input when the feature map of a pre-trained model or a target model is input to a first meta model as input, may determine the form of information to be transferred in the transfer learning, and may determine the amount of data to be transferred in each layer of the pre-trained model and the target model using a second meta model based on similarity between a source dataset and a target dataset.

Furthermore, the at least one processor performs transfer learning on a target model, but may perform the transfer-learning in such a manner that the attention map of the target model generated through a meta model becomes similar to the attention map of a pre-trained model generated through the meta model.

As described above, the transfer learning system implemented as a computer according to another embodiment may implement the transfer learning method, and a redundant description thereof is omitted.

As described above, the embodiments can provide a transfer learning technology for improving performance of a new target model that trains a new target dataset using a deep learning model previously trained using a source dataset. Accordingly, performance of the existing target model can be improved in many fields using transfer learning, and a source model can be used for the training of more various target models. Accordingly, it is expected that time and costs for the collection of datasets and the development of models for training a new task can be reduced.

The above-described system or device may be implemented in the form of a combination of hardware components, software components and/or hardware components and software components. For example, the device and components described in the embodiments may be implemented using one or more general-purpose computers or special-purpose computers, for example, a processor, a controller, an arithmetic logic unit (ALU), a digital signal processor, a microcomputer, a field programmable array (FPA), a programmable logic unit (PLU), a microprocessor or any other device capable of executing or responding to an instruction. A processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may be aware that the processing device may include a plurality of processing elements and/or a plurality of types of processing elements. For example, the processing device may include a plurality of processors or a single processor and a single controller. Furthermore, other processing configuration, such as a parallel processor, is also possible.

Software may include a computer program, code, an instruction or one or more combinations of them and may configure the processing device so that it operates as desired or may instruct the processing device independently or collectively. Software and/or data may be interpreted by the processing device or may be embodied in a machine, component, physical device, virtual equipment or computer storage medium or device of any type or a transmitted signal wave permanently or temporarily in order to provide an instruction or data to the processing device. Software may be distributed to computer systems connected over a network and may be stored or executed in a distributed manner. Software and data may be stored in one or more computer-readable recording media.

The method according to the embodiment may be implemented in the form of a program instruction executable by various computer means and stored in a computer-readable recording medium. The computer-readable recording medium may include a program instruction, a data file, and a data structure solely or in combination. The medium may continue to store a program executable by a computer or may temporarily store the program for execution or download. Furthermore, the medium may be various recording means or storage means of a form in which one or a plurality of pieces of hardware has been combined. The medium is not limited to a medium directly connected to a computer system, but may be one distributed over a network. An example of the medium may be one configured to store program instructions, including magnetic media such as a hard disk, a floppy disk and a magnetic tape, optical media such as CD-ROM and a DVD, magneto-optical media such as a floptical disk, ROM, RAM, and flash memory. Furthermore, other examples of the medium may include an app store in which apps are distributed, a site in which other various pieces of software are supplied or distributed, and recording media and/or store media managed in a server. Examples of the program instruction may include machine-language code, such as code written by a compiler, and high-level language code executable by a computer using an interpreter.

In accordance with embodiments, there are provided the method and system for transfer learning to a random target dataset and model structure based on meta learning, which improve performance of a new target model that trains a new target dataset using a deep learning model previously trained using a source dataset.

Furthermore, in accordance with embodiments, there can be provided the method and system for transfer learning to a random target dataset and model structure based on meta learning by providing a meta model that determines a degree of transfer and a form of transfer information by taking into consideration an associative relation between a pre-trained model and a source dataset and the structure of a new target model and a target dataset when the pre-trained model and the source dataset are given.

As described above, although the embodiments have been described in connection with the limited embodiments and the drawings, those skilled in the art may modify and change the embodiments in various ways from the description. For example, proper results may be achieved although the above-described descriptions are performed in order different from that of the described method and/or the above-described elements, such as the system, configuration, device, and circuit, are coupled or combined in a form different from that of the described method or replaced or substituted with other elements or equivalents.

Accordingly, other implementations, other embodiments, and the equivalents of the claims belong to the scope of the claims.

What is claimed is:

1. A transfer learning method, comprising steps of:
determining a form and amount of information to be transferred, used by a pre-trained model, using a meta model based on similarity between a source dataset and a new target dataset; and
performing transfer-learning on a target model using the form and amount of information of the pre-trained model determined by the meta model.

2. The transfer learning method of claim 1, further comprising a step of generating a virtual source dataset and a virtual target dataset through the source dataset used by the pre-trained model, training a virtual pre-trained model and a virtual target model, and training the meta model in order to be of help to the training.

3. The transfer learning method of claim 1, wherein the step of determining a form and amount of information to be transferred using a meta model comprises steps of:
generating an attention map to be used for the transfer learning as output when a feature map of the pre-trained model or target model is input to a first meta model as input and determining the form of information to be transferred in the transfer learning; and
determining an amount of data to be transferred in each of the pre-trained model and the target model, using a second meta model based on the similarity between the source dataset and the target dataset.

4. The transfer learning method of claim 3, wherein in the step of determining an amount of data to be transferred,
the amount of data to be transferred is a constant value output through the second meta model, and
the constant value is differently applied for each pair of layers.

5. The transfer learning method of claim 1, wherein in the step of performing transfer learning on the target model, the transfer learning is performed in such a manner that an attention map of the target model generated through the meta model becomes similar to an attention map of the pre-trained model generated through the meta model.

6. The transfer learning method of claim 5, wherein in the step of performing transfer learning on the target model, the transfer learning is performed to reduce an additional loss in such a manner that the attention map of the target model generated through the meta model becomes similar to the attention map of the pre-trained model generated through the meta model.

7. The transfer learning method of claim 2, wherein in the step of training the meta model, the meta model and the virtual target model are trained to minimize a loss function.

8. The transfer learning method of claim 1, wherein:
the pre-trained model and the target model comprise a deep learning model, and
the target model is trained through the new target dataset using a previously trained deep learning model.

9. A transfer learning system implemented as a computer, comprising:
at least one processor implemented to execute instructions readable by a computer,
wherein the at least one processor is configured to:
determine a form and amount of information to be transferred, used by a pre-trained model, using a meta model based on similarity between a source dataset and a new target dataset; and
perform transfer-learning on a target model using the form and amount of information of the pre-trained model determined by the meta model.

10. The transfer learning system of claim 9, wherein the at least one processor is configured to:
generate a virtual source dataset and a virtual target dataset through the source dataset used by the pre-trained model,
train a virtual pre-trained model and a virtual target model, and
train the meta model in order to be of help to the training.

11. The transfer learning system of claim 9, wherein the at least one processor is configured to:
determine the form and amount of information to be transferred using the meta model,
generate an attention map to be used for transfer learning as output when a feature map of the pre-trained model or target model is input to a first meta model as input and determine the form of information to be transferred in the transfer learning, and
determine an amount of data to be transferred in each of the pre-trained model and the target model, using a second meta model based on the similarity between the source dataset and the target dataset.

12. The transfer learning system of claim 9, wherein the at least one processor is configured to:
perform transfer learning on the target model, and
perform the transfer learning in such a manner that an attention map of the target model generated through the meta model becomes similar to an attention map of the pre-trained model generated through the meta model.

13. A transfer learning system, comprising:
a meta model unit configured to determine a form and amount of information to be transferred, used by a pre-trained model, based on similarity between a source dataset and a new target dataset,
wherein the meta model unit comprises:
a first meta model of generating an attention map to be used for transfer learning as output when a feature map of the pre-trained model or a target model is received as input and determining the form of information to be transferred in the transfer learning; and
a second meta model of determining the amount of data to be transferred in each layer of the pre-trained model and the target model based on the similarity between the source dataset and the target dataset.

14. The transfer learning system of claim 13, further comprising a meta model training unit configured to generate a virtual source dataset and a virtual target dataset through the source dataset used by the pre-trained model, train a virtual pre-trained model and a virtual target model, and train the meta model in order to be of help to training.

15. The transfer learning system of claim 13, further comprising a transfer learning unit configured to perform transfer learning on the target model using the form and amount of information to be transferred, determined by the meta model.

16. The transfer learning system of claim 13, wherein:
the amount of data to be transferred is a constant value output through the second meta model, and
the constant value is differently applied for each pair of layers.

17. The transfer learning system of claim 15, wherein the transfer learning unit performs transfer learning in such a manner that an attention map of the target model generated through the meta model becomes similar to an attention map of the pre-trained model generated through the meta model.

18. The transfer learning system of claim 17, wherein the transfer learning unit is trained to reduce an additional loss when the transfer learning is performed in such a manner that the attention map of the target model generated through the meta model becomes similar to the attention map of the pre-trained model generated through the meta model.

19. The transfer learning system of claim 14, wherein the meta model training unit trains the meta model and the virtual target model to minimize a loss function.

20. The transfer learning system of claim 13, wherein:
the pre-trained model and the target model comprise a deep learning model, and
the target model is trained through the new target dataset using a previously trained deep learning model.
